(19) United States
(12) Patent Application Publication
(10) Pub. No.: US 2024/0097380 A1
(43) Pub. Date: Mar. 21, 2024

(54) POWER CONVERSION DEVICE

(71) Applicant: HONDA MOTOR CO., LTD., Tokyo (JP)

(72) Inventors: Takahiro UNEME, Tokyo (JP); Ryuta WAKABAYASHI, Tokyo (JP); Mayuka ARAKI, Tokyo (JP)

(73) Assignee: HONDA MOTOR CO., LTD., Tokyo (JP)

(21) Appl. No.: 18/369,442

(22) Filed: Sep. 18, 2023

(30) Foreign Application Priority Data
Sep. 21, 2022 (JP) 2022-150436

(51) Int. Cl. H01R 13/621; H01R 12/55; H01R 13/512

(52) U.S. Cl. CPC H01R 13/6215; H01R 12/55; H01R 13/512; H01R 2201/26

(57) ABSTRACT

A power conversion device has at least one electronic component, an accommodating case configured to accommodate the electronic component, and a connector unit provided on the accommodating case. The connector unit includes a connector portion provided with an external terminal electrically connected to outside, and a conductive member extending from the connector portion and electrically connecting the connector portion and the electronic component. A fragile portion is formed in the conductive member.

### CROSS-REFERENCE TO RELATED APPLICATIONS

This application is based on and claims priority under 35 USC 119 from Japanese Patent Application No. 2022-150436 filed on Sep. 21, 2022, the contents of which are incorporated herein by reference.

### TECHNICAL FIELD

The present disclosure relates to a power conversion device mounted on an electric vehicle or the like.

### BACKGROUND ART

In recent years, efforts have been made to realize a low-carbon society or a decarbonized society. In a field of vehicles, research and development of electric vehicles with electrified drive sources are in progress in order to reduce an amount of CO₂ emission and improve energy efficiency.

A power conversion device is mounted on an electric vehicle or the like. The power conversion device, for example, converts DC power stored in a battery into three-phase AC power for driving a rotary electric machine that is a drive source of the electric vehicle, and steps down the DC power stored in the battery to an operating voltage of each electrical component such as an auxiliary machine mounted on the electric vehicle. For example, JP2022-089680A discloses a vehicle in which an assembly of a power control unit and a motor unit is mounted as a power conversion device.

A power supply cable connected to a battery is connected to an electronic control unit disclosed in JP2022-089680A. The power supply cable is connected to the electronic control unit by fitting a cable-side connector into a unit-side connector of the electronic control unit. A unit-side terminal provided in the unit-side connector of the electronic control unit is connected to an electronic component inside the power control unit.

In the electronic control unit disclosed in JP2022-089680A, a load such as an impact may be applied to the unit-side connector from the outside due to a collision of the vehicle or the like. However, in the electronic control unit disclosed in JP2022-089680A, when a load such as an impact is applied to the unit-side connector from the outside, the load such as the impact is transmitted from the unit-side connector, and the load such as the impact may be applied to the electronic component inside the power control unit.

### SUMMARY OF INVENTION

The present disclosure provides a power conversion device capable of preventing a load such as an impact from being applied to an electronic component accommodated in an accommodating case even when the load is applied to a connector unit from the outside.

An aspect of the present disclosure relates to a power conversion device including:
at least one electronic component;
an accommodating case configured to accommodate the electronic component; and
a connector unit provided on the accommodating case,
in which the connector unit includes:
   a connector portion provided with an external terminal electrically connected to outside; and
   a conductive member extending from the connector portion and electrically connecting the connector portion and the electronic component, and
a fragile portion is formed in the conductive member.

According to the present disclosure, since the fragile portion is formed in the conductive member, even when a load such as an impact is applied to the connector unit from the outside, the conductive member is deformed or broken at the fragile portion, and thus the load can be prevented from being applied to the electronic component accommodated in the accommodating case.

### BRIEF DESCRIPTION OF DRAWINGS

Exemplary embodiment(s) of the present invention will be described in detail based on the following figures, wherein:

FIG. 1 is a schematic perspective view of a vehicle equipped with a power control unit, which is a power conversion device according to a first embodiment of the present disclosure, as viewed obliquely from above;

FIG. 2 is a perspective view of the power control unit, which is the power conversion device according to the first embodiment of the present disclosure, as viewed obliquely from above;

FIG. 3 is a front view of the power control unit in FIG. 2 as viewed from a front side;

FIG. 4 is a main-portion top view of the power control unit in FIG. 2 as viewed from above with an upper member removed;

FIG. 5 is a main-portion cross-sectional view of the vicinity of a nut and a movable nut in the power control unit in FIG. 2 as viewed from the front side;

FIG. 6 is a top view of a low-voltage connector unit in the power control unit in FIG. 2 as viewed from above;

FIG. 7 is a top view of a main portion inside a front room of the vehicle in FIG. 1 as viewed from above; and

FIG. 8 is a top view of a low-voltage connector unit according to a second embodiment as viewed from above.

### DESCRIPTION OF EMBODIMENTS

Hereinafter, a vehicle equipped with a power conversion device according to embodiments of the present disclosure will be described with reference to the accompanying drawings. The drawings are viewed in directions of reference numerals. In the present specification and the like, in order to simplify and clarify the description, front-rear, left-right, and upper-lower directions are described according to directions viewed from a driver of the vehicle equipped with an integrated unit, and in the drawings, a front side of the vehicle is denoted by Fr, a rear side is denoted by Rr, a left side is denoted by L, a right side is denoted by R, an upper side is denoted by U, and a lower side is denoted by D. In the present specification and the like, the left-right direction is also referred to as a vehicle width direction.

### First Embodiment

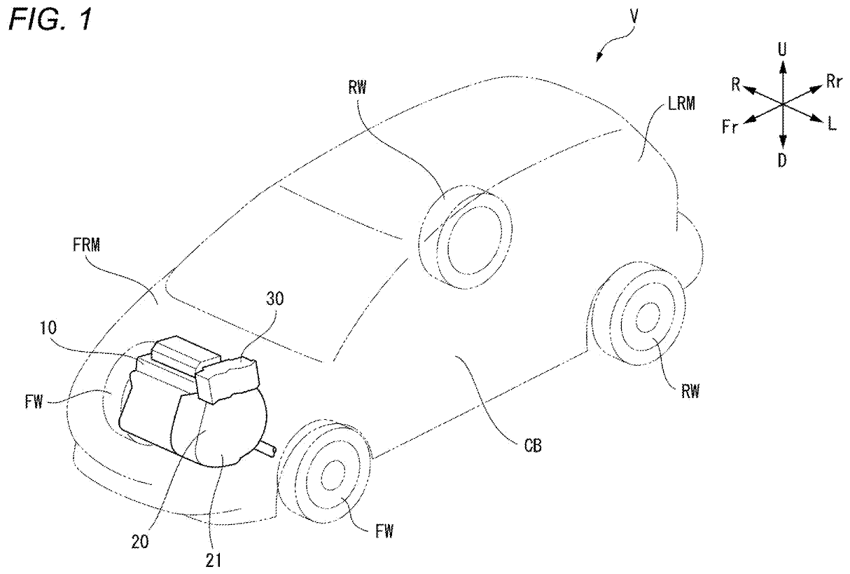

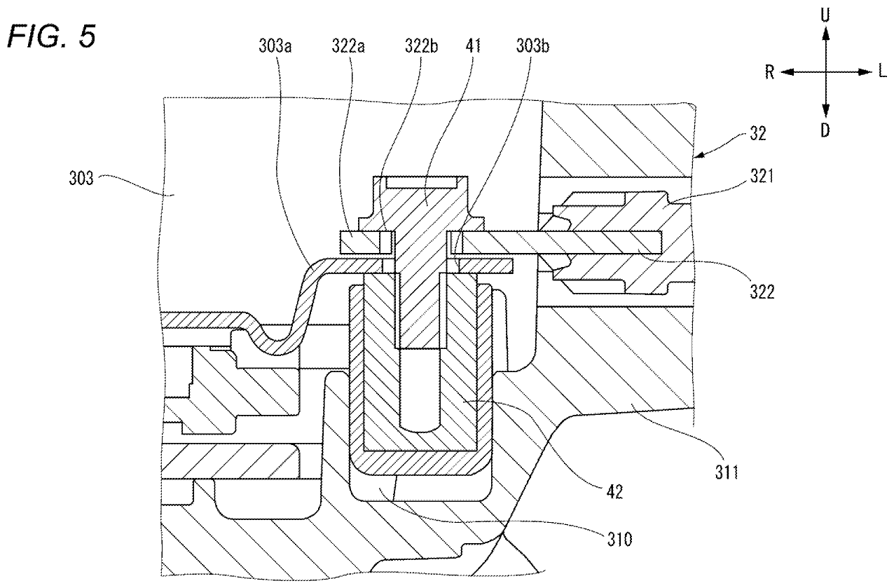

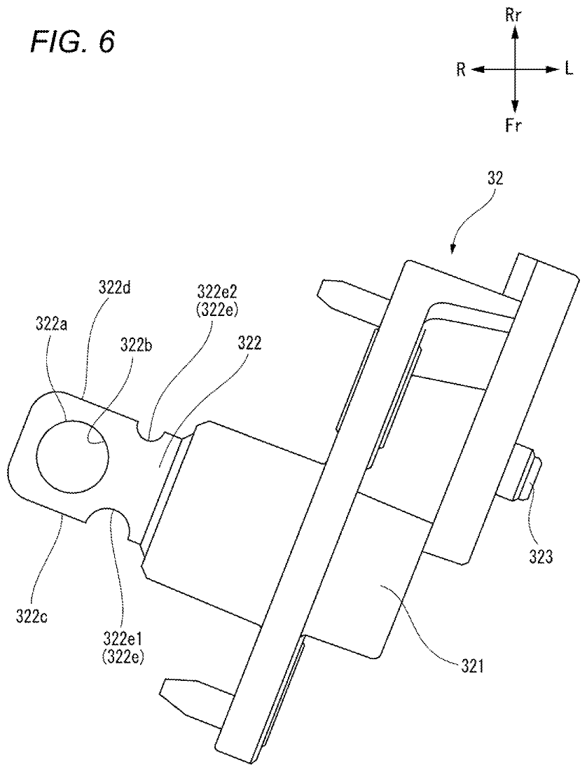

First, a vehicle equipped with a power conversion device according to a first embodiment of the present disclosure will be described with reference to FIGS. 1 to 6.

<Vehicle>

As shown in FIG. 1, a vehicle V according to the present embodiment includes a cabin CB that is a living space for an occupant, a front room FRM provided in front of the cabin CB, and a luggage room LRM provided behind the cabin CB. The cabin and the front room FRM are separate spaces partitioned by a dash panel (not shown) or the like. In the present embodiment, the luggage room LRM is not partitioned from the cabin CB, and is a space communicating with the cabin CB. The luggage room LRM and the cabin CB may be separate spaces, or may partially communicate with each other.

The vehicle V is provided with a pair of left and right front wheels FW on the front side and a pair of left and right rear wheels RW on the rear side.

An engine 10, a drive device 20, and a power control unit 30 are mounted in the front room FRM of the vehicle V. The engine 10 and the drive device 20 are disposed adjacent to each other in the vehicle width direction in the front room FRM. In the present embodiment, the engine 10 and the drive device 20 are disposed adjacent to each other in the vehicle width direction in the front room FRM such that the engine 10 is on a right side and the drive device 20 is on a left side. The power control unit 30 is fixed to an upper portion of the drive device 20.

An output shaft of the engine 10 is coupled to the drive device 20.

The drive device 20 includes a drive device case 21. A first rotary electric machine (not shown), a second rotary electric machine (not shown), and a power transmission mechanism (not shown) are accommodated in the drive device case 21.

The drive device 20 includes a transmission path that transmits rotational power of the engine 10 to the front wheels FW that are driven wheels via the power transmission mechanism to cause the vehicle to travel, and a transmission path that transmits the rotational power of the engine 10 to the first rotary electric machine via the power transmission mechanism to drive the second rotary electric machine while generating power with the first rotary electric machine and transmits rotational power of the second rotary electric machine to the front wheels FW that are the driven wheels via the power transmission mechanism to cause the vehicle to travel. The vehicle V travels by driving the front wheels FW, which are the driven wheels, by selectively selecting one of the two transmission paths in the drive device 20 or using the two transmission paths in combination.

The power control unit 30 is connected between a high-voltage battery (not shown) mounted on the vehicle V and the drive device 20. In the present embodiment, the power control unit 30 is an example of the power conversion device according to the present disclosure.

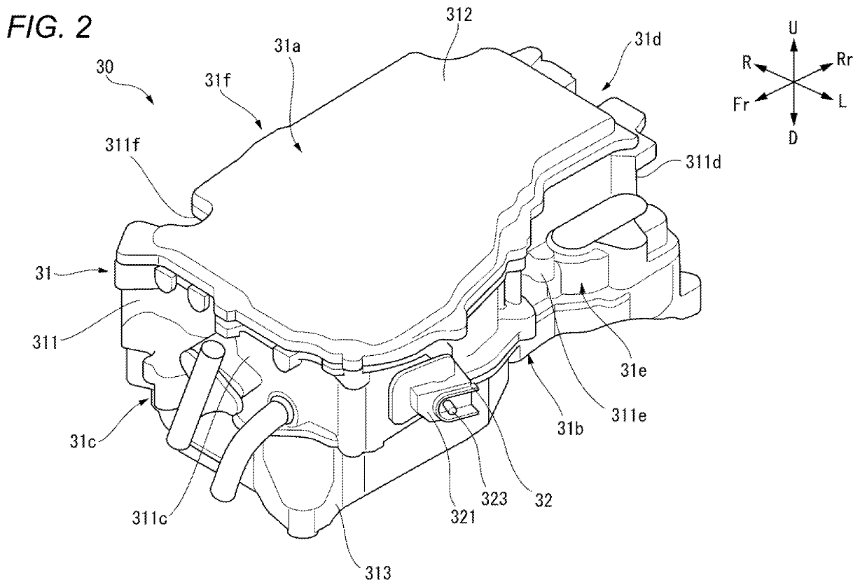

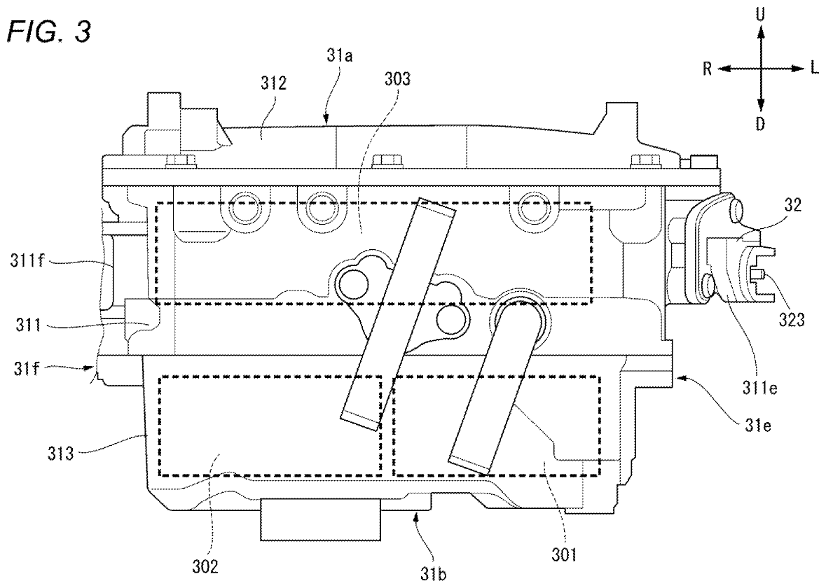

As shown in FIGS. 2 and 3, the power control unit 30 includes a voltage control unit 301, an inverter 302, a DCDC converter 303, an accommodating case 31, and a low-voltage connector unit 32 provided on the accommodating case 31.

The voltage control unit 301 is electrically connected to the high-voltage battery, and boosts a voltage V1, which is an output voltage of the high-voltage battery, to a voltage V2, which is an input voltage when the second rotary electric machine operates as an electric motor, and steps down power at the voltage V2, which is generated by the second rotary electric machine and converted into a direct current by driving of the engine 10, to power at the voltage V1.

The inverter 302 includes a first inverter unit (not shown) connected to the voltage control unit 301 and the first rotary electric machine, and a second inverter unit (not shown) connected to the voltage control unit 301 and the second rotary electric machine.

The first inverter unit converts AC power generated by the first rotary electric machine by the driving of the engine 10 into DC power at the voltage V2. Then, the DC power at the voltage V2 converted by the first inverter unit is stepped down to the voltage V1 by the voltage control unit 301, and the high-voltage battery is charged.

The second inverter unit converts the DC power output from the high-voltage battery and boosted to the voltage V2 by the voltage control unit 301 into three-phase AC power. Then, the three-phase AC power converted by the second inverter unit is supplied to the second rotary electric machine, and the second rotary electric machine is driven.

The DCDC converter 303 is electrically connected to the high-voltage battery in parallel with the voltage control unit 301, and is also electrically connected to the low-voltage connector unit 32. The DCDC converter 303 steps down the voltage V1, which is the output voltage of the high-voltage battery, to V_{Low}, which is an operating voltage of each electrical component of the vehicle. V_{Low} is, for example, 12 [V]. The power stepped down to V_{Low} by the DCDC converter 303 is output from the low-voltage connector unit 32 to the outside of the power control unit 30.

The accommodating case 31 accommodates the voltage control unit 301, the inverter 302, and the DCDC converter 303.

The accommodating case 31 includes an upper wall portion 31a, a lower wall portion 31b, a front wall portion 31c, a rear wall portion 31d, a left wall portion 31e, and a right wall portion 31f.

The accommodating case 31 includes an intermediate member 311 surrounding the voltage control unit 301, the inverter 302, and the DCDC converter 303 as viewed in the upper-lower direction, an upper member 312 disposed at an upper portion of the intermediate member 311 and covering an upper side of the voltage control unit 301, the inverter 302, and the DCDC converter 303, and a lower member 313 disposed at a lower portion of the intermediate member 311 and covering a lower side of the voltage control unit 301, the inverter 302, and the DCDC converter 303. The upper member 312 is fixed to an upper end portion of the intermediate member 311 by bolts or the like. The lower member 313 is fixed to a lower end portion of the intermediate member 311 by bolts or the like.

The upper wall portion 31a of the accommodating case 31 is formed by the upper member 312. The lower wall portion 31b of the accommodating case 31 is formed by the lower member 313. In each of the front wall portion 31c, the rear wall portion 31d, the left wall portion 31e, and the right wall portion 31f of the accommodating case 31, an upper region is formed by the upper member 312, a lower region is formed by the lower member 313, and an intermediate region in the upper-lower direction between the upper region and the lower region is formed by the intermediate member 311.

The intermediate member 311 includes a front wall portion 311c, a rear wall portion 311d, a left wall portion 311e, and a right wall portion 311f. The front wall portion 311c extends in the upper-lower direction and the left-right direction in front of the voltage control unit 301, the inverter 302, and the DCDC converter 303. The rear wall portion 311d extends in the upper-lower direction and the left-right direction behind the voltage control unit 301, the inverter 302, and the DCDC converter 303. The left wall portion 311e extends rearward from a left end portion of the front wall portion 311c to a left end portion of the rear wall portion 311d in the upper-lower direction and the front-rear direction. The right wall portion 311f extends rearward from a right end portion of the front wall portion 311c to a right end portion of the rear wall portion 311d in the upper-lower direction and the front-rear direction.

The low-voltage connector unit 32 is provided in a front region of the accommodating case 31. The low-voltage connector unit 32 is provided in a front region of the left wall portion 31e of the accommodating case 31 behind the front wall portion 31c of the accommodating case 31. In the present embodiment, the low-voltage connector unit 32 is provided on the intermediate member 311. Therefore, the low-voltage connector unit 32 is provided in a front region of the left wall portion 311e of the intermediate member 311. The low-voltage connector unit 32 is provided in the front region of the left wall portion 311e of the intermediate member 311 so as to extend obliquely forward to the left from the left wall portion 311e of the intermediate member 311, and is fixed to the left wall portion 311e of the intermediate member 311 by bolts or the like.

The DCDC converter 303 is fixed to the intermediate member 311 inside the accommodating case 31.

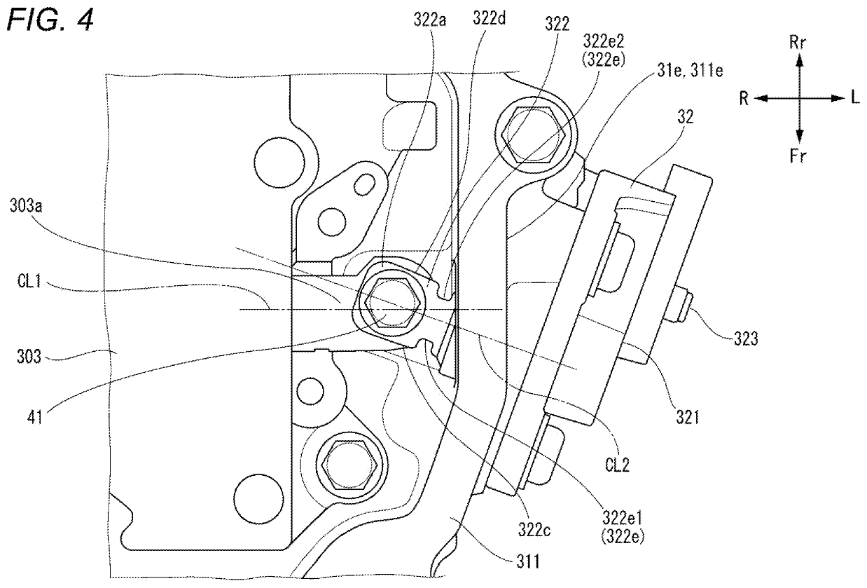

As shown in FIGS. 4 to 6, the DCDC converter 303 includes an output terminal portion 303a that extends from the DCDC converter 303 and outputs power. The output terminal portion 303a extends leftward from the DCDC converter 303. A bolt insertion hole 303b through which a bolt 41 can be inserted in the upper-lower direction is formed in the output terminal portion 303a.

The low-voltage connector unit 32 includes a connector portion 321 electrically connected to the outside, and a conductive member 322 extending from the connector portion 321 and electrically connecting the connector portion 321 and the DCDC converter 303.

The connector portion 321 is provided with an external terminal 323. One end portion of a DV electric wire 50 is connected to the connector portion 321. Then, the external terminal 323 is electrically connected to the DV electric wire 50.

The conductive member 322 is, for example, a bus bar. One end portion of the conductive member 322 in an extending direction of the conductive member 322 is coupled to the connector portion 321 and is electrically connected to the external terminal 323. A connection terminal portion 322a electrically connected to the output terminal portion 303a of the DCDC converter 303 is provided at the other end portion of the conductive member 322 in the extending direction of the conductive member 322. A bolt insertion hole 322b through which the bolt 41 can be inserted in the upper-lower direction is formed in the connection terminal portion 322a.

The conductive member 322 extends obliquely rearward to the right from the connector portion 321. That is, the conductive member 322 extends from a right rear side to a left front side. Therefore, the conductive member 322 extends such that a center line CL2 in the extending direction of the conductive member 322 is oblique at a predetermined angle with respect to a center line CL1 in an extending direction of the output terminal portion 303a extending leftward from the DCDC converter 303. In the present embodiment, the connection terminal portion 322a of the conductive member 322 is coupled to the output terminal portion 303a of the DCDC converter 303, and the conductive member 322 extends such that the center line CL2 in the extending direction of the conductive member 322 is oblique at the predetermined angle with respect to the center line CL1 in the extending direction of the output terminal portion 303a and extends obliquely forward to the left from the connection terminal portion 322a.

As viewed from above, a nut accommodating portion 310 is formed in the intermediate member 311 of the accommodating case 31 at a position overlapping with the bolt insertion hole 303b formed in the output terminal portion 303a of the DCDC converter 303 and the bolt insertion hole 322b formed in the connection terminal portion 322a of the conductive member 322. The nut accommodating portion 310 is a recess having a bottomed cylindrical shape whose upper side is open.

A movable nut 42 movable in the upper-lower direction is attached to the accommodating case 31. The movable nut 42 is accommodated in the nut accommodating portion 310 and is attached to the intermediate member 311 of the accommodating case 31 so as to be movable in the upper-lower direction.

Then, the bolt 41 is inserted from above into the bolt insertion hole 303b formed in the output terminal portion 303a of the DCDC converter 303 and the bolt insertion hole 322b formed in the connection terminal portion 322a of the conductive member 322, and is screwed to the movable nut 42. Accordingly, since the output terminal portion 303a of the DCDC converter 303 and the connection terminal portion 322a of the conductive member 322 are fastened together by the bolt 41 and the movable nut 42, the connection terminal portion 322a of the conductive member 322 is fastened to the output terminal portion 303a of the DCDC converter 303. Since the movable nut 42 is attached to the accommodating case 31, the conductive member 322 and the output terminal portion 303a of the DCDC converter 303 are attached to the accommodating case 31 via the movable nut 42.

Since a nut screwed with the bolt 41 is the movable nut 42 movable in the upper-lower direction that is an axial direction of the bolt 41, when the connection terminal portion 322a of the conductive member 322 is fastened to the output terminal portion 303a of the DCDC converter 303 by the bolt 41 and the movable nut 42, the conductive member 322 and the output terminal portion 303a of the DCDC converter 303 can be prevented from being deformed by an axial force of the bolt 41.

The conductive member 322 includes a front edge portion 322c of the conductive member 322 extending in the extending direction of the conductive member 322, and a rear edge portion 322d, which is opposite to the front edge portion 322c, of the conductive member 322 extending in the extending direction of the conductive member 322, as viewed in the upper-lower direction that is the axial direction of the bolt 41.

A fragile portion 322e is formed in the conductive member 322. The fragile portion 322e is more easily deformed or broken than other portions of the conductive member 322.

Therefore, even when a load such as an impact is applied to the low-voltage connector unit 32 from the outside due to a collision of the vehicle V or the like, the conductive member 322 is deformed or broken at the fragile portion 322e, and thus the load can be prevented from being applied to the DCDC converter 303 accommodated in the accommodating case 31. Accordingly, even when the load such as the impact is applied to the low-voltage connector unit 32 from the outside due to the collision of the vehicle V or the like, the DCDC converter 303 can be prevented from being damaged.

As described above, the conductive member 322 extends such that the center line CL2 in the extending direction of the conductive member 322 is oblique at the predetermined angle with respect to the center line CL1 in the extending direction of the output terminal portion 303a and extends obliquely forward to the left from the connection terminal portion 322a. Therefore, when a load such as an impact is applied from the front side due to a frontal collision of the vehicle V or the like, stress is preferentially generated in the conductive member 322 rather than in the output terminal portion 303a of the DCDC converter 303, and large stress is generated in the conductive member 322. Accordingly, when the load such as the impact is applied to the low-voltage connector unit 32 from the outside, stress generated in the output terminal portion 303a of the DCDC converter 303 can be reduced, and the DCDC converter 303 can be further prevented from being damaged.

In the present embodiment, the fragile portion 322e is formed between the bolt insertion hole 322b and the connector portion 321 in the extending direction of the conductive member 322.

Therefore, when a load such as an impact is applied to the low-voltage connector unit 32 from the outside, the conductive member 322 is deformed or broken at the fragile portion 322e between the bolt insertion hole 322b and the connector portion 321, and thus the connection terminal portion 322a of the conductive member 322 connected to the output terminal portion 303a of the DCDC converter 303 is prevented from being deformed. Accordingly, even when the load such as the impact is applied to the low-voltage connector unit 32 from the outside, the load can be further prevented from being applied to the DCDC converter 303.

In the present embodiment, the fragile portion 322e has a first notch portion 322e1 and a second notch portion 322e2. The first notch portion 322e1 is formed in the front edge portion 322c of the conductive member 322. The first notch portion 322e1 has a shape cut out in a substantially arc shape toward the rear side from the front edge portion 322c of the conductive member 322. The second notch portion 322e2 is formed in the rear edge portion 322d of the conductive member 322. The second notch portion 322e2 has a shape cut out in a substantially arc shape toward the front side from the rear edge portion 322d of the conductive member 322. Both the first notch portion 322e1 and the second notch portion 322e2 are formed between the bolt insertion hole 322b and the connector portion 321 in the extending direction of the conductive member 322.

The first notch portion 322e1 and the second notch portion 322e2 have different notched depths. In the present embodiment, the first notch portion 322e1 formed in the front edge portion 322c of the conductive member 322 is deeper than the second notch portion 322e2 formed in the rear edge portion 322d of the conductive member 322.

When the load such as the impact is applied from the front side due to the frontal collision of the vehicle V or the like, a load in a tensile direction with respect to the extending direction of the conductive member 322 is applied to the front edge portion 322c of the conductive member 322, whereas a load in the tensile direction with respect to the extending direction of the conductive member 322 is applied to the rear edge portion 322d of the conductive member 322. At this time, when the load such as the impact is applied from the front side, the first notch portion 322e1 formed in the front edge portion 322c of the conductive member 322 to which the load in the tensile direction with respect to the extending direction of the conductive member 322 is applied is deeper than the second notch portion 322e2 formed in the rear edge portion 322d of the conductive member 322, and thus the front edge portion 322c of the conductive member 322 is more easily broken from the first notch portion 322el. Accordingly, when the load such as the impact is applied from the front side, the conductive member 322 is more easily broken from the first notch portion 322e1, and thus the load can be further prevented from being applied to the DCDC converter 303.

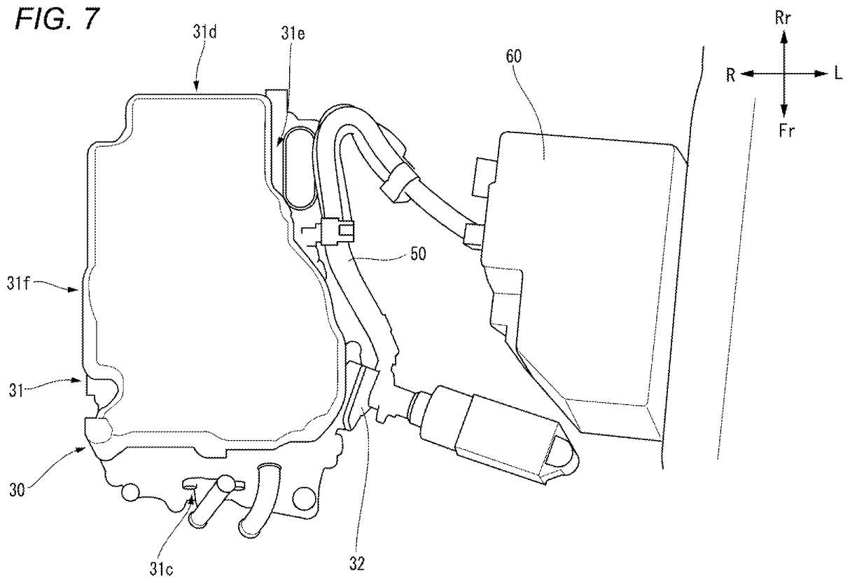

As shown in FIG. 7, the one end portion of the DV electric wire 50 is connected to the connector portion 321 of the low-voltage connector unit 32. The one end portion of the DV electric wire 50 is connected to the external terminal 323 provided in the low-voltage connector unit 32 of the power control unit 30, and the other end portion is connected to a relay box 60 mounted inside the front room FRM of the vehicle V.

Power output from the external terminal 323 provided in the low-voltage connector unit 32 of the power control unit 30 is transmitted from the DV electric wire 50 to the relay box 60, and is supplied from the relay box 60 to each electrical component mounted on the vehicle V.

### Second Embodiment

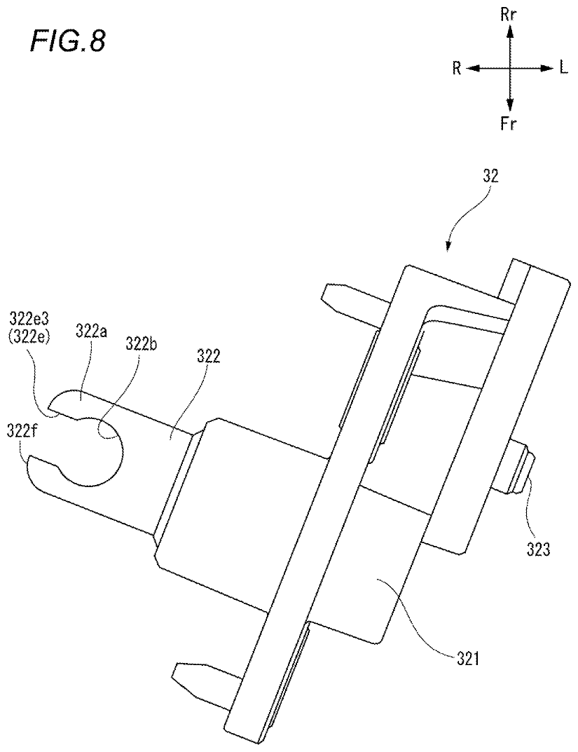

Next, the power control unit 30 as a power conversion device according to a second embodiment of the present disclosure will be described with reference to FIG. 8. In the following description, the same components as those of the power control unit 30 according to the first embodiment are denoted by the same reference numerals, and the description thereof will be omitted or simplified. In the power control unit 30 according to the first embodiment, the fragile portion 322e is formed between the bolt insertion hole 322b and the connector portion 321 in the extending direction of the conductive member 322, and has the first notch portion 322e1 and the second notch portion 322e2, but the position and shape of the fragile portion 322e are different in the power control unit 30 according to the second embodiment. Hereinafter, differences between the power control unit 30 according to the first embodiment and the power control unit 30 according to the second embodiment will be described in detail.

In the present embodiment, the fragile portion 322e has a cutout groove 322e3 that communicates with the bolt insertion hole 322b from a right edge portion 322f of the conductive member 322 located on a side opposite to the connector portion 321 with respect to a center of the bolt insertion hole 322b in the extending direction of the conductive member 322, that is, a right rear end, as viewed in the upper-lower direction that is an axial direction of the bolt 41.

Therefore, when a load such as an impact is applied to the low-voltage connector unit 32 from the outside, the conductive member 322 is deformed such that the cutout groove 322e3 is widely opened, the bolt 41 is removed from the cutout groove 322e3 of the conductive member 322, and fastening between the output terminal portion 303a of the DCDC converter 303 and the conductive member 322 is released. Accordingly, even when the load such as the impact is applied to the low-voltage connector unit 32 from the outside, the load can be further prevented from being applied to the DCDC converter 303.

Although the embodiments of the present disclosure have been described above with reference to the accompanying drawings, it is needless to say that the present invention is not limited to the embodiments. It is apparent that those skilled in the art can conceive of various modifications and changes within the scope described in the claims, and it is understood that such modifications and changes naturally fall within the technical scope of the present invention. In addition, the components in the above embodiments may be combined as desired without departing from the gist of the invention.

For example, the external terminal 323 of the low-voltage connector unit 32 may be electrically connected to an electronic component other than the DCDC converter 303.

In the present embodiment, the vehicle V is a so-called front wheel drive vehicle having the front wheels FW as driven wheels, but the vehicle V may be a so-called rear wheel drive vehicle having the rear wheels RW as driven wheels, or may be a so-called four wheel drive vehicle having both the front wheels FW and the rear wheels RW as driven wheels. When the vehicle V is a four wheel drive vehicle, the drive device 20 may include a drive shaft coupled to an axle of the rear wheels RW and a front differential gear that distributes a driving force to the left and right front wheels FW. In this case, the drive device 20 drives the front wheels FW via the front differential gear and drives the rear wheels RW via the front differential gear and the drive shaft. The drive device 20 may include a transmission path that transmits rotational power of the engine 10 to the front wheels FW via the power transmission mechanism and transmits the rotational power of the engine 10 to the rear wheels RW via the drive shaft, and a transmission path that transmits the rotational power of the engine 10 to the first rotary electric machine via the power transmission mechanism to drive the second rotary electric machine while generating power with the first rotary electric machine, transmits rotational power of the second rotary electric machine to the front wheels FW via the power transmission mechanism and transmits the rotational power of the second rotary electric machine to the rear wheels RW via the drive shaft. In this case, the vehicle V travels by driving the front wheels FW and the rear wheels RW by selectively selecting one of the two transmission paths in the drive device 20 or using the two transmission paths in combination. When the vehicle V is the four wheel drive vehicle, the drive device 20 may include a third rotary electric machine at a rear portion of the vehicle V, and may further include a transmission path that transmits the rotational power of the engine 10 to the front wheels FW via the power transmission mechanism to cause the vehicle V to travel, a transmission path that transmits the rotational power of the engine 10 to the first rotary electric machine via the power transmission mechanism to drive the second rotary electric machine while generating power with the first rotary electric machine and transmits rotational power of the second rotary electric machine to the front wheels FW via the power transmission mechanism to cause the vehicle V to travel, and a transmission path that transmits the rotational power of the engine 10 to the first rotary electric machine via the power transmission mechanism to drive the third rotary electric machine while generating power with the first rotary electric machine and transmits rotational power of the third rotary electric machine to the rear wheels RW to cause the vehicle V to travel. In this case, the vehicle V travels by driving the front wheels FW or both the front wheels FW and the rear wheels RW by selecting one or more of the three transmission paths in the drive device 20 or using the three transmission paths in combination.

In the present specification, at least the following matters are described. In parentheses, corresponding components and the like in the above embodiments are shown as an example, but the present invention is not limited thereto.

(1) There is provided a power conversion device (power control unit 30) including:
at least one electronic component (DCDC converter 303);
an accommodating case (accommodating case 31) configured to accommodate the electronic component; and
a connector unit (low-voltage connector unit 32) provided in the accommodating case.

The connector unit includes
a connector portion (connector portion 321) provided with an external terminal (external terminal 323) electrically connected to the outside, and
a conductive member (conductive member 322) extending from the connector portion and electrically connecting the connector portion and the electronic component.

A fragile portion (fragile portion 322e) is formed in the conductive member.

According to (1), even when a load such as an impact is applied to the connector unit from the outside, the conductive member is deformed or broken at the fragile portion, and thus the load can be prevented from being applied to the electronic component accommodated in the accommodating case. Accordingly, even when the load such as the impact is applied to the connector unit from the outside, the electronic component can be prevented from being damaged.

(2) In the power conversion device according to (1),
the electronic component includes an output terminal portion (output terminal portion 303a) extending from the electronic component and configured to output power,
the conductive member includes a connection terminal portion (connection terminal portion 322a) fastened to the output terminal portion of the electronic component by a bolt (bolt 41) and a nut (movable nut 42), and
the nut is a movable nut attached to the accommodating case and movable in an axial direction of the bolt.

According to (2), since a nut screwed with the bolt is the movable nut movable in the axial direction of the bolt, when the connection terminal portion of the conductive member is fastened to the output terminal portion of the electronic component by the bolt and the nut, the conductive member and the output terminal portion of the electronic component can be prevented from being deformed by an axial force of the bolt.

(3) In the power conversion device according to (1),
the electronic component includes an output terminal portion (output terminal portion 303a) extending from the electronic component and configured to output power,
the conductive member includes a connection terminal portion (connection terminal portion 322a) fastened to the output terminal portion of the electronic component by a bolt (bolt 41) and a nut (movable nut 42), and
the conductive member extends such that a center line (center line CL2) in an extending direction of the conductive member is oblique at a predetermined angle with respect to a center line (center line CL1) in an extending direction of the output terminal portion extending from the electronic component.

According to (3), since the conductive member extends such that the center line in the extending direction of the conductive member is oblique at the predetermined angle with respect to the center line in the extending direction of the output terminal portion, when a load such as an impact is applied from a side of a direction in which the center line in the extending direction of the conductive member is oblique with respect to the center line in the extending direction of the output terminal portion, stress is preferentially generated in the conductive member rather than in the output terminal portion of the electronic component, and large stress is generated in the conductive member. Accordingly, when the load such as the impact is applied to the connector unit from the outside, stress generated in the output terminal portion of the electronic component can be reduced, and the electronic component can be further prevented from being damaged.

(4) In the power conversion device according to (1),
the electronic component includes an output terminal portion (output terminal portion 303a) extending from the electronic component and configured to output power,
the conductive member includes a connection terminal portion (connection terminal portion 322a) fastened to the output terminal portion of the electronic component by a bolt (bolt 41) and a nut (movable nut 42),
a bolt insertion hole (bolt insertion hole 322b) through which the bolt is inserted is formed in the connection terminal portion, and
the fragile portion is formed between the bolt insertion hole and the connector portion in an extending direction of the conductive member.

According to (4), when a load such as an impact is applied to the connector unit from the outside, the conductive member is deformed or broken at the fragile portion formed between the bolt insertion hole and the connector portion, and thus the connection terminal portion of the conductive member connected to the output terminal portion of the electronic component is prevented from being deformed. Accordingly, even when the load such as the impact is applied to the connector unit from the outside, the load can be further prevented from being applied to the electronic component.

(5) In the power conversion device according to (4),
the fragile portion has a first notch portion (first notch portion 322e1) and a second notch portion (second notch portion 322e2),
the first notch portion is formed in a first edge portion (front edge portion 322c) of the conductive member extending in an extending direction of the conductive member as viewed in a bolt axial direction that is an axial direction of the bolt,
the second notch portion is formed in a second edge portion (rear edge portion 322d) of the conductive member extending in the extending direction of the conductive member so as to be opposite to the first edge portion as viewed in the bolt axial direction, and
the first notch portion and the second notch portion have different notched depths.

According to (5), since the first notch portion and the second notch portion have different notched depths, when a load such as an impact is applied from a direction on a side where a notch portion having a larger notched depth is formed, among the first notch portion and the second notch portion, the conductive member is more easily broken from the notch portion having the larger notched depth, among the first notch portion and the second notch portion. Accordingly, the load can be further prevented from being applied to the electronic component.

(6) In the power conversion device according to (1),
the electronic component includes an output terminal portion (output terminal portion 303a) extending from the electronic component and configured to output power,
the conductive member includes a connection terminal portion (connection terminal portion 322a) fastened to the output terminal portion of the electronic component by a bolt (bolt 41) and a nut (movable nut 42),
a bolt insertion hole (bolt insertion hole 322b) through which the bolt is inserted is formed in the connection terminal portion, and
the fragile portion has a cutout groove (cutout groove 322e3) communicating with the bolt insertion hole from an end edge (right edge portion 322f) of the conductive member located on a side opposite to the connector portion with respect to a center of the bolt insertion hole in an extending direction of the conductive member, as viewed in a bolt axial direction that is an axial direction of the bolt.

According to (6), when a load such as an impact is applied to the connector unit from the outside, the conductive member is deformed such that the cutout groove is widely opened, the bolt is removed from the cutout groove of the conductive member, and fastening between the output terminal portion of the electronic component and the conductive member is released. Accordingly, even when the load such as the impact is applied to the connector unit from the outside, the load can be further prevented from being applied to the electronic component.

What is claimed is:

1. A power conversion device comprising:
at least one electronic component;
an accommodating case configured to accommodate the electronic component; and
a connector unit provided on the accommodating case,
wherein the connector unit includes:
a connector portion provided with an external terminal electrically connected to outside; and
a conductive member extending from the connector portion and electrically connecting the connector portion and the electronic component, and
a fragile portion is formed in the conductive member.

2. The power conversion device according to claim 1,
wherein the electronic component includes an output terminal portion extending from the electronic component and configured to output power,
the conductive member includes a connection terminal portion fastened to the output terminal portion of the electronic component by a bolt and a nut, and
the nut is a movable nut attached to the accommodating case and movable in an axial direction of the bolt.

3. The power conversion device according to claim 1,
wherein the electronic component includes an output terminal portion extending from the electronic component and configured to output power,
the conductive member includes a connection terminal portion fastened to the output terminal portion of the electronic component by a bolt and a nut, and
the conductive member extends such that a center line in an extending direction of the conductive member is oblique at a predetermined angle with respect to a center line in an extending direction of the output terminal portion extending from the electronic component.

4. The power conversion device according to claim 1,
wherein the electronic component includes an output terminal portion extending from the electronic component and configured to output power,
the conductive member includes a connection terminal portion fastened to the output terminal portion of the electronic component by a bolt and a nut,
a bolt insertion hole through which the bolt is inserted is formed in the connection terminal portion, and
the fragile portion is formed between the bolt insertion hole and the connector portion in an extending direction of the conductive member.

5. The power conversion device according to claim 4,
wherein the fragile portion has a first notch portion and a second notch portion,
the first notch portion is formed in a first edge portion of the conductive member extending in an extending direction of the conductive member as viewed in a bolt axial direction that is an axial direction of the bolt,
the second notch portion is formed in a second edge portion, which is opposite to the first edge portion, of the conductive member extending in the extending direction of the conductive member as viewed in the bolt axial direction, and
the first notch portion and the second notch portion have different notched depths.

6. The power conversion device according to claim 1,
wherein the electronic component includes an output terminal portion extending from the electronic component and configured to output power,
the conductive member includes a connection terminal portion fastened to the output terminal portion of the electronic component by a bolt and a nut,
a bolt insertion hole through which the bolt is inserted is formed in the connection terminal portion, and
the fragile portion has a cutout groove communicating with the bolt insertion hole from an end edge of the conductive member located on a side opposite to the connector portion with respect to a center of the bolt insertion hole in an extending direction of the conductive member, as viewed in a bolt axial direction that is an axial direction of the bolt.
